(19) United States
(12) Patent Application Publication
(10) Pub. No.: US 2006/0118760 A1
(43) Pub. Date: Jun. 8, 2006

(54) Slurry composition and methods for chemical mechanical polishing

(76) Inventors: Andy Chunxiao Yang, Shanghai (CN); Chris Chang Yu, Shanghai (CN)

Correspondence Address: TRAN & ASSOCIATES, 6768 MEADOW VISTA CT., SAN JOSE, CA, 95135, US

(21) Appl. No.: 11/004,326

(22) Filed: Dec. 3, 2004

(51) Int. Cl. C09K 13/00; C09K 13/04

(52) U.S. Cl. 252/79.1; 252/79.2; 216/88

(57) ABSTRACT

A chemical-mechanical planarization (CMP) slurry comprising at least one abrasive particles at least one oxidizer, and at least one carrier. The abrasive particles can be selected from: a particle with all soft material, a particle having a soft outer material and a hard inner material, an inner charged particle, a magnetized particle, and an empty core particle. The substrate to be polished can be Aluminum, Copper, Ti, TiN, Ag. W, or their alloys, Oxide, Ni—P, Si₃N₄ for example.

### BACKGROUND

The present invention relates to slurry compositions for chemical-mechanical planarization (CMP).

The process for fabricating integrated circuits and other electronic devices typically forms or deposits multiple layers of conducting, semiconducting, and dielectric materials on a surface of a substrate. Layers of conducting, semiconducting, and dielectric materials may be deposited by various deposition techniques such as physical vapor deposition (PVD), also known as sputtering, chemical vapor deposition (CVD), plasma-enhanced chemical vapor deposition (PECVD), and electrochemical plating (ECP).

As layers of materials are sequentially deposited and removed, the uppermost surface of the substrate may become non-planar across its surface and require planarization. Planarizing a surface, or “polishing” a surface, is a process where material is removed from the surface of the substrate to form a generally even planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical mechanical planarization, or chemical mechanical polishing (CMP), is a common technique used to planarize substrates. CMP utilizes a chemical composition, typically a slurry or other fluid medium, for selective removal of material from substrates. In conventional CMP techniques, a substrate carrier or polishing head is mounted on a carrier assembly and positioned in contact with a polishing pad in a CMP apparatus. The carrier assembly provides a controllable pressure to the substrate urging the substrate against the polishing pad. The pad is moved relative to the substrate by an external driving force. Thus, the CMP apparatus affects polishing or rubbing movement between the surface of the substrate and the polishing pad while dispersing a polishing composition, or slurry, to affect both chemical activity and mechanical activity.

Conventional slurries used for CMP processes contain abrasive particles in a reactive solution. Alternatively, the abrasive article can be a fixed abrasive article, such as a fixed abrasive polishing pad, which maybe used with a CMP composition or slurry that does not contain abrasive particles. A fixed abrasive article typically comprises a backing sheet with a plurality of geometric abrasive composite elements adhered thereto.

Abrasives which are most extensively used in the semiconductor CMP process are silica (SiO₂), alumina (Al₂O₃), ceria (CeO₂), zirconia (ZrO₂), and titania (TiO₂), which can be produced by a fuming or a sol-gel method, as described in U.S. Pat. Nos. 4,959,113; 5,354,490; and 5,516,346 and WO97/40,030. There has recently been reported a composition or a slurry comprising mangania (Mn₂O₃) (European Pat. No. 816,457) or a silicon nitride (SiN) (European Pat. No. 786,504).

U.S. Pat. No. 6,508,952 discloses a CMP slurry containing any commercially available abrasive agent in particle form, such as SiO₂, Al₂O₃, ZrO₂, CeO₂, SiC, Fe₂O₃, TiO₂, Si₃N₄, or a mixture thereof. These abrasive particles normally have a high purity, a high surface area, and a narrow particle size distribution, and thus are suitable for use in abrasive compositions as abrasive agents.

U.S. Pat. No. 5,525,191 discloses that the pH, the polishing slurry, and types of polishing particles within a polishing slurry can be chosen so that polishing product is capable of coating onto the polishing particles. More specifically, the pH of the polishing slurry is selected to be between the iso-electric points of the polishing product and the particles within the polishing slurry. More than one type of material may be used within the polishing slurry. Particles of one material may do most of the polishing, while the particles of the other material become coated with polishing product and aid in transporting it away from the substrate.

U.S. Pat. No. 4,549,374 discloses polishing semiconductor wafers with an abrasive or slurry prepared by dispersing montmorillonite clay in deionized water. The pH of the slurry is adjusted by adding alkali such as NaOH and KOH.

US Patent Application Publication 2003/0129838 (filed Dec. 28, 1999) discloses the following non-plate-like abrasive materials: iron oxide, strontium titanate, apatite, dioptase, iron, brass, fluorite, hydrated iron oxide, and azurite.

U.S. Patent Application Publication 2004/0216388 discloses a CMP slurry in which the abrasive is formed of particles having a “non-spherical” morphology wherein at least one dimension (height, length and/or width) is substantially larger than another. The non-spherical particle morphology may be plate-like, sheet-like, needle-like, capsule-like, laminar-like, or any other of a myriad of shapes having at least one dimension substantially larger than another. Such morphology distinguishes over spherical particles which are substantially round in appearance and do not have noticeable elongated surfaces. Laminar clays such as kaolin, vermiculite and montmorillonite (that can be exfoliated) and modifications of such clays that preserve the clay shape such as acid leached kaolin, mica, talc, graphite flake, glass flake, and synthetic polymer flake are useful as abrasives in the CMP slurries Although all the above particles have been disclosed, still there is a need, more so recently, to form a proper slurry composition or system to meet new polishing requirements, such as surface finishing, fast removal rate, low defectivity and proper polishing selectivity. In particular, the novel slurry compositions disclosed in this invention are suited for achieving extremely smooth and highly reflective soft metal surfaces.

### SUMMARY

In one aspect, a chemical-mechanical planarization (CMP) slurry includes at least one abrasive particle, at least one oxidizer, and at least one carrier. In another aspect, a chemical-mechanical planarization (CMP) slurry comprising at least one abrasive particles, passivation or film forming agent, pH adjustor, dispersion surfactants, complexants (complexing agents), etching agents and special additives.

The abrasive types can include a number of particles, including: soft particles, outer soft but inner hard dual-portion particles, inner charged particles, magnetized particles, empty core particles and mixed particles. The particles can be small in size at 10-90 nm with properties for improving the defect, dishing, erosion and roughness, reflectivity and various material slurries selectivity during polishing performance. In particles with dual portions, the particle's hardness can be selected between the two portion's hardness in order to obtain a desired polishing selectivity.

The abrasive can be include SiO₂, Al₂O₃, CaCO₃, ZrO, CeO₂, TiO₂ Si₃N₄, AlN, TiN. SiC Al(OH)₃, polymer (for example polyethylene and PTFE), and inorganic/organic materials or their combination. The selection of the particle can be based on the hardness of the passivation film and the slurry's pH value.

Softer particles such as polyethylene, PTFE have a pH that is at a different iso-electric point from the solution can be used to reduce or eliminate the defect issue. The selection of the particles can also be adjusted to provide a slightly harder particle based on a desired removal rate and based on the hardness and thickness of a passivation layer (such as SiO₂ or Al₂O₃). Chemicals can be used to form a passivation layer made from the following: Al₂O₃, Al(OH)₃, and special organic compounds or their combination.

The chemicals in the slurries include the buffer and the passivation agents. These chemicals can make different surface conditions and therefore can have a different polishing rate between the Al or Al alloy and other materials, for example, HDP, PETEOS, SRO, BPSG, FSG, low k materials and any other oxides and dielectric materials to obtain a desired polishing selectivity.

The chemicals used to form the passivation layer can be selected from (but not limited to) H₂O₂, salt of S₂O₄²⁻ or S₂O₈²⁻, KIO₃, Fe(NO₃)₂, KMnO₄, KNO₃ HNO₃, Bromate, Bromine, Butadiene, Chlorates, Chloric acid, Chlorine, Chlorites, Chromates, Chromic Acid, Dichromates, Fluorine, haloates, Halogens, hypochlorites, Nitrous oxide, Ozanates, oxides, oxygen, oxygen difluoride ozone, peracetic acid perborates, perhaloate, percarbonates, perchlorates, perchloric acid, perhydrates, peroxides, persulfates, permanganates, sodium borate and sulfuric acid, NaOH, KOH, compounds containing element N, or S, or O, or P, or Zn, or πbond such as 1,2,3-benzotriazole(BTA), Indene, Benzofuran (coumarone), thionahpithene, 1-benzazole, 4-isobenzazole, indolenine or pseudoisoindole, isoindzzole, indazole, benzimidazole, indiazole, 1-pyrido[2,3-d]-υ-triazole, 1-pyrazolo pyrazine, 2-υ-triazolo[b]pyrazine, 1,2-benzeisoxzoble.benzopseudoxazole, benzofurazan, and purine.

The etching agent can be selected from but not limited to the HCl, HF, H₃PO₄, H₂SO₄ HNO₃ among others.

The pH value for the particles can be 3.5-12, and 8-11 is a preferred range because in this region, the passivation layer, Al₂O₃ and Al(OH)₃ is easily to be formed and more stable. The pH value can be tuned using buffer of either organic or inorganic chemical such as, potassium hydrogen, phthalate, ammonium citrate, ammonium phosphate, and ammonium acetate, among others.

The dispersion agent can include polyethylene glycol, polyoxyethylene ether, glycerol, polypropylene glycol, polyvinylalcohol, polyacrylic acid, polymethyl acrylic acid, acrylic acid-axylate copolymer), acrlic acid-hydroxypropyl acrylate copolymer, acrylic acrylate copolymer copolymer of maleic acid and acrylic acid, acrylic acid-hydroxypropyl acrylate ternary polymer, BOF, polyvinyl alcohol modified by copolymerization, copolymer of alkanolalkyl methacrylate with alkanolamine, maleic-styrene copolymer and polyethylene glycol mono methyl copolymer, carboxylic acid modified polyvinylalcohol, derivative of copolymer of ethylene glycol and polyamine, specific copolymer dispersant, hydroxy propyl acrylat and any other copolymer of monomers, isobutene, propylene oxide, 2-hydroxyethyl, methyl acrylate, maleic anhydride, acrylic acid, methacrylic acid acrylamide methyl acrylamide styrene, and vinyl pyridine ketone, among others.

The surfactant can include polyvinylalcohol, polyacrylic acid, polymethyl acrylic acid, acrylic acid-axylate copolymer), acrlic acid-hydroxypropyl acrylate copolymer, acrylic acrylate copolymer copolymer of maleic acid and acrylic acid, acrylic acid-hydroxypropyl acrylate ternary polymer, BOF, polyvinyl alcohol modified by copolymerization, copolymer of alkanolalkyl methacrylate with alkanolamine, maleic-styrene copolymer and polyethylene glycol mono methyl copolymer, carboxylic acid modified polyvinylalcohol, derivative of copolymer of ethylene glycol and polyamine, specific copolymer dispersant, hydroxy propyl acrylat and any other copolymer of monomers, isobutene, propylene oxide, 2-hydroxyethyl, methyl acrylate, maleic anhydride, acrylic acid, methacrylic acid acrylamide methyl acrylamide styrene, vinyl pyridine ketone etc or their combination.

Complexing agents can be used to help the Al film etching and to remove the polishing product so that there will be an ideal polishing rate and high degree of cleanness. The complex agents can include triethanolamine, ethylenediamine, ammonium citrate, ammonium phosphate, ammonium oxalate, EDTA, CyDTA, DTPA, EDTP, EGTA, HEDTA, NTA, Tetren, and Trien among others.

In one implementation for aluminum (Al) or Al alloy CMP processing according to the polishing mechanism, through optimizing the components of slurries and process parameters, an Al or Al alloy film with properties of low roughness, high degree of planarization, high reflectivity, low erosion and dishing, low defect, expected (and desired) thickness and structure, or any combination of the above features can be obtained.

Advantages of the slurry composition may include one or more of the following. The slurry provides soft metal polishing with improved colloidal stability, reduced defect level, enhanced surface smoothness, and improved material selectivity. The slurry compositions offer advantages including low corrosion, dishing, erosion, scratch, particle issue, and they can achieve high reflectivity and good planarization.

The composition can be used in a variety of polishing mechanisms. For example, an Al or Al alloys CMP process that optimizes the components of slurries and the process parameters can produce an Al or Al alloy film with properties of low roughness, high planarization, high reflectivity surface, low erosion and dishing, less defects, and/or an expected (and desired) thickness and structure.

The slurry is applicable for large wafer since the slurry assists in maintaining uniformity over larger length scales as compared to an 8″, or 200 mm, wafer. The slurry enables the fabrication of small and high density circuit patterns on integrated circuits as the slurry enable fine isolation structures to be made. This is needed to achieve increased circuit density by decreasing the space between the individual pathways without shorting out the connection.

The slurry is thus applicable to manufacturing high speed integrated circuits having submicron design features and high conductivity interconnect structures with high production throughput. In particular, the slurry is applicable to manufacture chips requiring highly smooth and optically reflective soft metal surfaces such as mirrors.

### BRIEF DESCRIPTION OF THE DRAWINGS

The present invention can be more fully understood by reading the subsequent detailed description in conjunction with the examples and references made to the accompanying drawings, wherein:

FIG. 1A shows an exemplary abrasive with soft particles.

FIG. 1B shows an exemplary abrasive with hard particles and long chain organic molecules.

FIG. 2 shows an exemplary particle with a dual-portion structure.

FIG. 3A shows an exemplary charged particle with three portions.

FIG. 3B shows an exemplary charged particle dispersed in an inside portion of the particle.

FIG. 4A shows an exemplary particle where magnetized materials are distributed inside the particle.

FIG. 4B shows an exemplary particle where magnetized materials are distributed in an inside portion of the particle.

FIG. 4C shows an exemplary particle where magnetized materials are distributed on the surface of an inside portion of the particle.

FIG. 5 shows an exemplary hollow-core particle.

FIGS. 6A-6H show an exemplary process for polishing a wafer and exemplary structures formed by FIG. 6A.

### DESCRIPTION

In general, slurry compositions that can be used for CMP in accordance with one aspect of the invention include one or more of the following: abrasives, passivation agents, buffers, dispersion surfactants, complexants (complexing agents), etching agents and special additives.

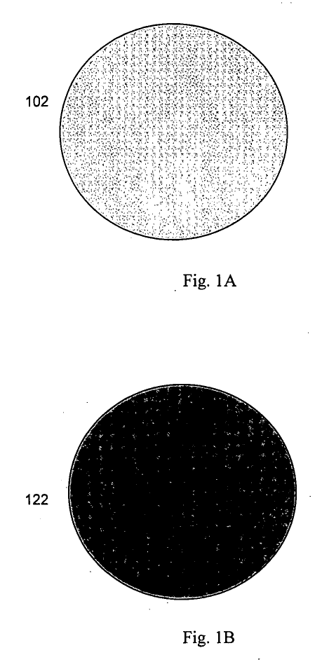

In a first embodiment shown in FIG. 1A, abrasive particles 102 are soft particles suitable for polishing soft materials such as aluminum and silver for a fine surface. The abrasive(s) are selected from a group of relatively soft particles including but not limited to amorphous SiO₂, AlO(OH), Al(OH)₃, ZrO₂, polyethylene, PTFE or other polymer. Soft abrasives avoid or minimize scratches on the Al film during polishing.

FIG. 1B shows an alternative embodiment that uses hard particles 122. In this embodiment, long chain organic molecules adsorbed on the hard portion of the particle can be added to act effectively as “soft shell” on the hard particles.

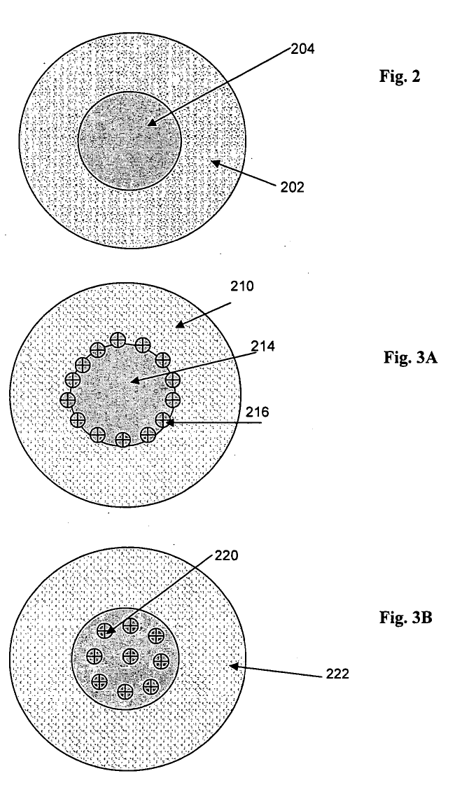

Turning now to FIG. 2, a polishing particle with a dual-portion structure is shown. An outer portion 202 includes a relative soft material and the inner portion 204 includes a relatively hard material.

The soft core or material is relatively a softer material comparing with the substrate to be polished, and in general their hardness is no more than 6 comparing with the diamond hardness.

The hard core or material is relatively a harder material comparing with the substrate to be polished, and in general their hardness is no less than 5 comparing the diamond hardness.

The soft material can include but not limited to materials such as amorphous SiO₂, AlO(OH), Al(OH)₃, ZrO₂, polyethylene, PTFE or other suitable polymer. The soft material can also be long-chain organic molecules adsorbed on the hard portion 504 of the particle. The hard materials can be selected from the following exemplary materials: CeO₂, Al₂O₃, and SiC, among others.

Various techniques can be used to form the dual portion structure of FIG. 2. For example, the inner hard portion 204 can initially be formed in a solution, and the resulting inner hard portion 204 can then be placed into another solution to grow the outer portion 202 of the particle after the inner portion 204 has reached a desired target size. In another embodiment, the condition for growing the inner hard portion 204 is controlled at a predetermined concentration and/or temperature, for example, to create conditions favorable for growing a compact structure and therefore harder particle. Subsequently, the particle growing condition is altered (such as a different concentrations and/or temperature and/or one or more other additives) that favors the growth of a loose structure and therefore a softer particle surface layer. In yet another embodiment, the dual-portion structure can be obtained by softening the surface of a hard particle by chemical or physical methods. This kind of abrasive particle can eliminate or minimize scratches on the Al film while maintaining a high Al polishing removal rate.

FIG. 3A shows another embodiment with an inner charged particle having three portions 210-216. An outer portion 210 includes a layer of dielectric. The dielectric layer for the outer portion 210 can be made from SiO₂, AlO(OH), Al(OH)3, ZrO₂, TiO₂, A₂Ol₃ CeO₂, polyethylene, PTFE, among other polymers. An inner portion 214 can include either metal or dielectric materials. Charge (positive or negative) of or in the inner portion, will have two kinds of distribution. One is forming a charge layer 216 between the outside and inside portions 210-214, (for example through the charge transfer method) The charged layer 216 can be also formed by depositing a charged material between the outer and inner layers or portions 210-214.

As shown in FIG. 3B, the charge can also be dispersed in an inside portion 220 that is enclosed by an outside portion 222. Particles with this structure can be produced by any of the methods which can be realized using methods such as implantation doping method. The charged composite particles tend to disperse themselves evenly rather than to aggregate with each other, resulting in a stable abrasive dispersion in the slurry, even during the polishing operation. Therefore, the scratch defect caused by the abrasive aggregation can be reduced or eliminated.

Second charged particles which have the same charge but stronger charge (either more positive or more negative potential to the first charged particle) can be added to help the dispersion of the particles and prevent particle aggregation. As an example, suppose a particle A is a hard particle and negatively charged exists in a solution as a main abrasive. When a particle B, the second particle which is more negatively charged, is added into the solution, particle A is dispersed away from particle B and the solution becomes more stable due to repulsive forces between the particles A and B. Furthermore, if particle B, is a soft one, during the polishing, the presence of particle B can alleviate the collisions between particle A or reduce the collision probability of particle A, which reduces the abrasive's aggregation. Finally, the aggregation is reduced and any remaining amount of aggregation of the abrasives causes minimal amount of scratches when only particle A is present. Thus, the presence of particle B reduces aggregation and turns the particle softer. This exemplary mechanism is not limited to the above embodiment and more than two particle types can be used.

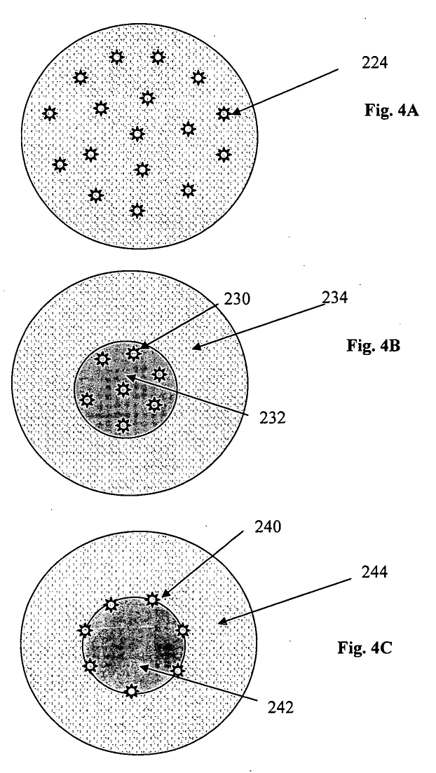

Magnetized polishing particles are discussed next. FIGS. 4A-4C show exemplary magnetized particles with the same structures shown in FIG. 2 and FIGS. 3A-3B. The difference is that a magnetized material is provided on or inside the particle. Thus, in FIG. 4A, magnetized materials 224 are evenly distributed inside a polishing particle. In FIG. 4B, magnetized materials 230 are positioned within an inner core or portion 232, both of which are in turn enclosed by an outer core or portion 234. In FIG. 4C, magnetized materials 240 are positioned on the surface of an inner core or portion 242, both of which are in turn enclosed by an outer core or portion 244. Thus, magnetized materials can be placed on the surface of the particle's inner portion, as shown in FIG. 4C, within the inner portion as shown in FIG. 4B or distributed in the whole particle body, as shown in FIG. 4A. The magnetized particles naturally distribute themselves evenly within the particle of FIGS. 4A-4C, and prevent scratches caused by the abrasive aggregation.

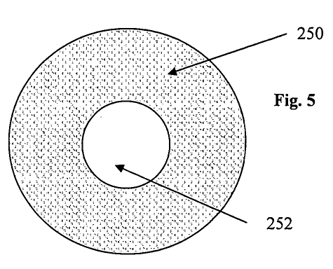

FIG. 5 shows yet another embodiment with an empty inner core or portion 252 of a particle 250. The structure of the particle 250 is easily transfigured under the polishing press, which leads to a larger contact area with a polished film therefore provides a faster removal rate as compared with a solid type particle. The material is used to build the shell of the particle can be hard or soft. In the mean time, its effective hardness may be lower than its solid counterpart. Yet another important advantage is the improvement of colloidal stability for heavy particles, the approach will reduce or eliminate setting due to weight. This type of particle has a large surface area and therefore, they are also more effective in removing reaction products.

Any combinations of the above particles can be used to produce a slurry with a desired selectivity. In one case, the particle's hardness is a value that is between the two portion's hardness. To illustrate, during the surface finishing polishing process, a slurry with a higher oxide removal rate over Al removal rate is desired so that no oxide residue remains on the Al film surface. At the same time, the Al film thickness should be preserved in order to have a uniform Al film across the wafer. To achieve this purpose, the slurry should be able to passivate the Al film surface (for example, forming Al₂O₃) to form in an oxide layer a softer layer. The particles in the slurry should have a hardness value between the values for the oxide film and Al₂O₃ film. Thus, during CMP, the oxide layer can be easily removed from the Al surface without significant loss of Al film thickness, resulting in a controlled, layer by layer removal, which is oxide first, and then is the Al surface layer, on a microscopic scale.

In addition, the smaller the particle, the easier the dispersion of the particles in the slurry and the more stable the particles. That is, compared with a solution with larger particles, the solution with smaller particles will not aggregate as much during storage or during the CMP process. Moreover, the solution with smaller particles is better for surface finishing, for example, reducing roughness of the surface to obtain a high reflectivity, than the larger particle. Therefore, particles with a relatively small size between 10 nm to 90 nm are used.

Next, the operation of the slurry composition with an exemplary CMP process is discussed. In one example, an Al CMP process with a polishing mechanism and an etching mechanism is discussed below.

a. Polishing Mechanism

For polishing mechanism, the removal of Al film is accomplished through the passivation layer's (for example, Al₂O₃) formation and removal. That is, a passivation layer is formed first in a certain solution, then it is removed by polishing, leaving an exposed fresh Al film. The fresh Al surface is next passivated again. This cycle is repeated, and the Al film is continuously removed. If there is no polishing, the Al's etching or dissolution will be stopped by the formation of passivation layer. The mechanism needs a fast passivation agent and the passivation layer should be compact. Moreover, during polishing, the etching rate of Al film is much slower than the formation rate of passivation layer.

b. Etching Mechanism

For etching mechanism, still there exists the passivation layer on the Al film but it can not stop the Al etching completely. In other words, it only reduces or slows down the etching rate of Al film. When the polishing is applied, the passivation layer is removed and the Al film's etching becomes fast. Al film etching becomes the main factor for the removal of Al film. In this mechanism, the Al film's thinning rate from Al's etching is fast enough to reach or even exceeds that forming the passivation layer's removal. The passivation layer has the characteristics of being loose or porous; its formation is not faster than its removal rate. Although this mechanism can avoid the scratch issue to some degree, its uniformity is hard to control. Further, because the relatively high etching rate, it results in a rough surface. It is also expected that dishing and erosion will be higher.

c. Polishing-Etching Co-Work Mechanism

If the passivation layer is made resistant to removal under a certain process conditions, the passivation layer will only be partially removed. A partially removed passivation layer loses its passivation function, and etching can occur. This is called polishing etching co-work mechanism. This mechanism can be realized by tuning the process parameter or adding chemicals, for example, a passivation layer loosing agent or combinations of chemicals.

The polishing-etching co-work mechanism can be used to thin and planarize the Al film. Because the uniformity can be controlled, scratches or other defects are minimized under the protection of the compact or hard passivation layer or under the loosed or soft passivation layer during the polishing.

Organic compounds or surfactants can be used to form the passivation layer and let the CMP performed as the polishing mechanism a discussed above (surfactant passivation or surfactant-assisted passivation mechanism). Also, the surfactant can help to passivate the Al film completely in the etching mechanism. By tuning the process parameters a polishing-etching co-work mecnhanism can be realized.

The etching agent for all above mentioned mechanism can include HCl, HF, H₃PO₄, H₂SO₄ HNO₃, among others.

For passivation agents, the slurry composition can use various substances as the passivation layer of the Al film: Al₂O₃, Al(OH)₃, and an organic compound (surfactant), among others.

The Al₂O₃ passivation layer can be obtained by using the oxidant selected from, but not be limited to, a group consisting of H₂O₂, salt of S₂O₄²⁻ or S₂O₈²⁻, KIO₃, Fe(NO₃)₂, KMnO₄, KNO₃HNO₃, bromate, Bromine, Butadiene, Chlorates, Chloric acid, Chlorine, Chlorites, Chromates, Chromic Acid, Dichromates, Fluorine, haloates, Halogens, hypochlorites, Nitrous oxide, Ozanates, oxides, oxygen, oxygen difluoride ozone, peracetic acid perborates, perhaloate, percarbonates, perchlorates, perchloric acid, perhydrates, peroxides, persulfates, permanganates, sodium borate and sulfuric acid.

The Al(OH)₃ passivation layer can be obtained by using the base selected from, but not be limited, to a group consisting of NaOH, KOH, among others.

The surfactants (or etch inhibiters) can include a group consisting of compounds containing element N, or S, or O, or P, or Zn, or πbond such as 1,2,3-benzotriazole(BTA), Indene, Benzofuran(coumarone), thionahpithene, 1-benzazole, 4-isobenzazole, indolenine or pseudoisoindole, isoindzzole, indazole, benzimidazole, indiazole, 1-pyrido[2,3-d]-υ-triazole, 1-pyrazolo pyrazine, 2-υ-triazolo[b]pyrazine, 1,2-benzeisoxzoble.benzopseudoxazole, benzofurazan, and purine.

By optimizing the passivation condition (the concentration of passivation agent, temperature of passivation, and other chemicals, among others), the selectivity of the slurries can be tuned (optimized). For example, when adding a strong oxidant in a solution with a pH at about 11 (that is, there are many OH⁻s in the solution), the oxide surface on the wafer will become rather rough and loose, while the Al film surface will be a dense layer a smooth Al₂O₃ passivation film, thus the polishing under this condition will have a good selectivity between the oxide and Al.

Th pH value for the slurry composition can be between 3.5-12. The pH value can also be between 8-11 because in this region, the passivation layer, Al₂O₃ and Al(OH)₃ can form easily and be more stable. The pH value can be tuned using a buffer that can be either organic or inorganic. Exemplary buffers include potassium hydrogen, phthalate, ammonium citrate, ammonium phosphate, and ammonium acetate, among others.

The dispersion agent can be selected but not limited to a group consisting of polyethylene glycol, polyoxyethylene ether, glycerol, polypropylene glycol, polyvinylalcohol, polyacrylic acid, polymethyl acrylic acid, acrylic acid-axylate copolymer), acrlic acid-hydroxypropyl acrylate copolymer, acrylic acrylate copolymer copolymer of maleic acid and acrylic acid, acrylic acid-hydroxypropyl acrylate ternary polymer, BOF, polyvinyl alcohol modified by copolymerization, copolymer of alkanolalkyl methacrylate with alkanolamine, maleic-styrene copolymer and polyethylene glycol mono methyl copolymer, carboxylic acid modified polyvinylalcohol, derivative of copolymer of ethylene glycol and polyamine, specific copolymer dispersant, hydroxy propyl acrylat and any other copolymer of monomers, isobutene, propylene oxide, 2-hydroxyethyl, methyl acrylate, maleic anhydride, acrylic acid, methacrylic acid acrylamide methyl acrylamide styrene, and vinyl pyridine ketone, among others.

Complex agents can be used to help Al film etching and to remove polishing product so that there will be an ideal polishing rate and cleanness degree. The complex agent can include triethanolamine, ethylenediamine, ammonium citrate, ammonium phosphate, ammonium oxalate, EDTA, CyDTA, DTPA, EDTP, EGTA, HEDTA, NTA, Tetren, and Trien, among others.

In addition, special additives can be used to minimize scratches on the wafer being polished. The special additives prevent the solvent from being volatile from the slurry bulk. The additives minimizes the slurry's crystallization due to a loss of humidity. The special additives can easily and strongly and densely congregate together on the surface of the solution to minimize or eliminate the volatilization of solvent altogether.

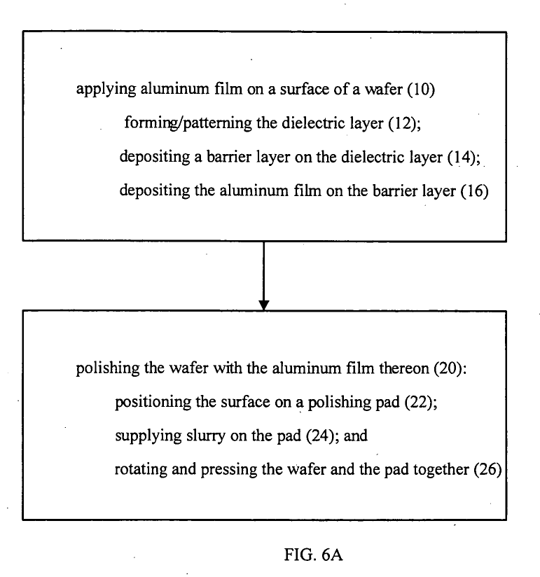

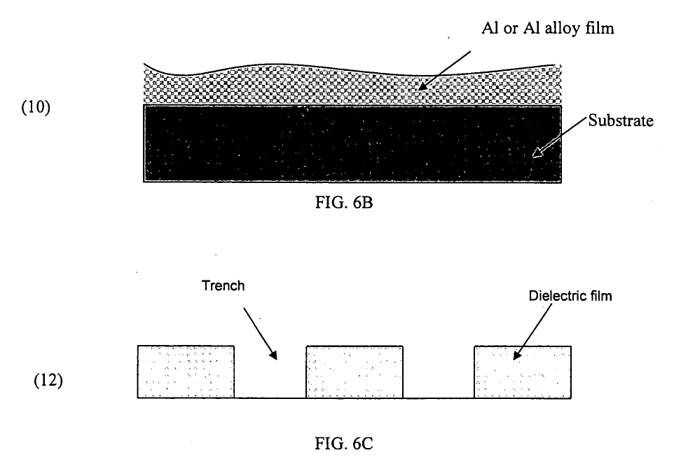

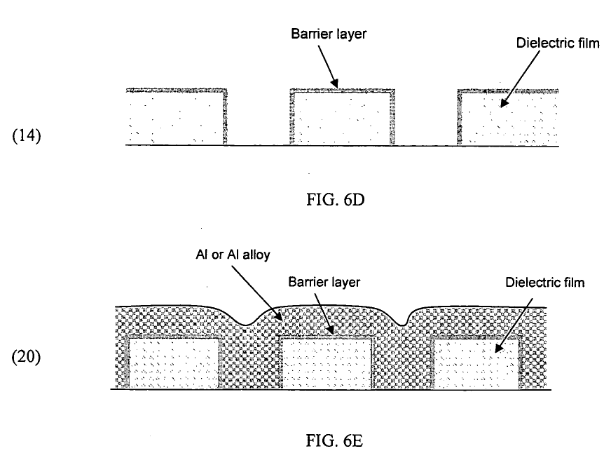

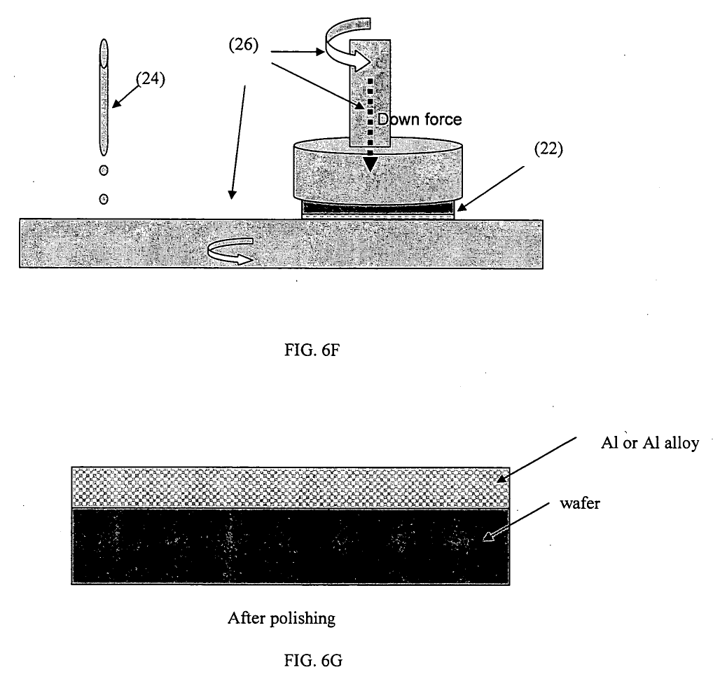

FIG. 6A shows an exemplary process for semiconductor fabrication, while FIGS. 6B-6H show exemplary fabricated structures corresponding to the process of FIG. 6A. The process of FIG. 6A forms an aluminum (Al) layer or film on a surface of a wafer (10) and polishes the wafer with the aluminum layer or film thereon (20).

In one implementation, the formation of the aluminum film on the wafer surface includes forming/patterning the dielectric layer (12); depositing a barrier layer on the dielectric layer (14); and depositing the aluminum film on the barrier layer (16). The polishing of the wafer with the aluminum film includes positioning the surface on a polishing pad (22); supplying polishing slurry on the pad (24); and rotating and pressing the wafer and the pad at the same time (26). Subsequently, the residue on the wafer can be removed.

The system forms an aluminum film and polishes the wafer with the aluminum film. The film can be either pure aluminum metal or aluminum alloy. The aluminum alloy can be used to harden the metal mirror surface and therefore to reduce or avoid the defect issue. Further, it may improve electro-migration resistance of the film.

Implementations of the process of FIG. 6A may include one or more of the following. The dielectric layer can be HDP, PETEOS, SRO, BPSG, FSG, low k materials and any other oxides and dielectric materials formed using CVD, PVD, spin-on or any other suitable methods. The patterning of the dielectric layer can be realized using dry etching or wet etching. The forming of the metal Al or Al alloy layer includes but not limited to electro-plating, chemical plating, CVD or PVD, among others.

The polished layers include Al or Al alloys, barrier layer, and dielectric layer, with the removal of dielectric layer typically minimized, the resulting metal Al or Al alloy is also co-planar with the dielectric surface. The polishing rate between the Al or Al alloy, barrier layer and the dielectric layer can be either the same or different as specified by the details of the processing. Typically, a lower dielectric layer removal rate is preferred.

In one implementation, the slurry can contain abrasive, surfactant, oxidant, complexant, inhibitor, buffer and catalyst, among others. The CMP head down force is no less than 3 psi. The turntable rotation speed is no less than 50 rpm. The head rotation speed is no less than 50 rpm. The slurry flow rate is between 100-500 ml/min and 150 ml/min is preferred. The Al or Al alloys polishing rate is no less than 2000 A/min. The CMP pad can be selected from IC 1000, IC 1010 or other Polyurethane or hard pad. The Al metal or Al alloy can have 0.1% to 5% of impurity.

The slurries for polishing Al or Al alloys can contain abrasive, passivation agents, etching Agent, surfactants, complexing agent, inhibiter, buffer, and special additives, and the polishing mechanism can be any suitable polishing mechanism including controlled etching mechanism, polishing-etching co-work mechanism and surfactants passivation or surfactants assisted passivation mechanism, which have detailed explanation in this article, or their combination. The abrasive can be SiO₂, Al₂O₃, CaCO₃, ZrO, CeO₂, TiO₂ Si₃N₄, AlN, TiN. SiC Al(OH)₃, polymer (for example polyethylene and PTFE), inorganic and organic materials or their combination. The selection of the particle can be based on the hardness of the passivasion film and the pH value of the slurry. Basically, softer particle, for example, polyethylene, PTFE and a pH different iso-electric point from the solution are preferred to reduce or eliminate the defect issue. The selection of the harder particles with empty inner portion can provide a faster removal rate in polishing while maintaining a low defect level. and can be made of or covered by hard and thick passivation layer, for example, SiO₂, Al₂O₃.

While the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A chemical-mechanical planarization (CMP) slurry comprising at least one abrasive particle, at least one oxidizer, and at least one carrier.

2. The CMP slurry of claim 1, comprising one of the following abrasive particles: a particle with a soft material compared with the substrate to be polished, a particle having a soft outer material and a hard inner material, an inner charged particle, a magnetized particle, and an empty core particle.

3. The CMP slurry of claim 2, wherein the abrasive particle is used for surface finishing and selective polishing.

4. The CMP slurry of claim 2, wherein the abrasive particle comprises one of the following: SiO₂, Al₂O₃, CaCO₃, ZrO, CeO₂, TiO₂ Si₃N₄, AlN, TiN. SiC Al(OH)₃, polymer including polyethylene and PTFE.

5. The CMP slurry of claim 1, wherein a particle comprises two portions and the hardness of the particle hardness is between the hardness of the two portions.

6. The CMP slurry of claim 1, comprising one or more chemicals to form a passivation layer.

7. The CMP slurry of claim 6, wherein the passivation layer comprises one of: Al₂O₃, Al(OH)₃, and an organic compound.

8. The CMP slurry of claim 1, comprising a buffer and a passivation agents

9. The CMP slurry of claim 1, comprising one or more of the following to form a passivation layer: H₂O₂, salt of S₂O₄²⁻ or S₂O₈²⁻, KIO₃, Fe(No₃)₂, KMnO₄, KNO₃ HNO₃, bromate, Bromine, Butadiene, Chlorates, Chloric acid, Chlorine, Chlorites, Chromates, Chromic Acid, Dichromates, Fluorine, haloates, Halogens, hypochlorites, Nitrous oxide, Ozanates, oxides, oxygen, oxygen difluoride ozone, peracetic acid perborates, perhaloate, percarbonates, perchlorates, perchloric acid, perhydrates, peroxides, persulfates, permanganates, sodium borate and sulfuric acid, NaOH, KOH, compounds containing element N, or S, or O, or P, or Zn, or πbond such as 1,2,3-benzotriazole(BTA), Indene, Benzofuran(coumarone), thionahpithene, 1-benzazole, 4-isobenzazole, indolenine or pseudoisoindole, isoindzzole, indazole, benzimidazole, indiazole, 1-pyrido[2,3-d]-υ-triazole, 1-pyrazolo pyrazine, 2-υ-triazolo[b]pyrazine, 1,2-benzeisoxzoble, benzopseudoxazole, benzofurazan, and purine.

10. The CMP slurry of claim 1, comprising one or more of the following etching agents: HCl, HF, H₃PO₄, H₂SO₄ and HNO₃.

11. The CMP slurry of claim 1, wherein the slurry has a pH value between 3.5 and 12.

12. The CMP slurry of claim 1, wherein the slurry has a pH value between 8 and 11.

13. The CMP slurry of claim 1, wherein has a pH value tuned using one of the following: an organic/inorganic acid/base and their salts.

14. The CMP slurry of claim 13, wherein the buffer comprises one of: potassium hydrogen, sodium hydrogen, phthalate, ammonium citrate, ammonium phosphate, and ammonium acetate.

15. The CMP slurry of claim 1, comprising a surfactant including one of: polyvinylalcohol, polyacrylic acid, polymethyl acrylic acid, acrylic acid-axylate copolymer), acrlic acid-hydroxypropyl acrylate copolymer, acrylic acrylate copolymer copolymer of maleic acid and acrylic acid, acrylic acid-hydroxypropyl acrylate ternary polymer, BOF, polyvinyl alcohol modified by copolymerization, copolymer of alkanolalkyl methacrylate with alkanolamine, maleic-styrene copolymer and polyethylene glycol mono methyl copolymer, carboxylic acid modified polyvinylalcohol, derivative of copolymer of ethylene glycol and polyamine, specific copolymer dispersant, hydroxy propyl acrylat and any other copolymer of monomers, isobutene, propylene oxide, 2-hydroxyethyl, methyl acrylate, maleic anhydride, acrylic acid, methacrylic acid acrylamide methyl acrylamide styrene, and vinyl pyridine ketone.

16. The CMP slurry of claim 1, comprising a complexing agent including one of: triethanolamine, ethylenediamine, ammonium citrate, ammonium phosphate, ammonium oxalate, EDTA, CyDTA, DTPA, EDTP, EGTA, HEDTA, NTA, Tetren, and Trien.

17. The CMP slurry of claim 1, comprising an additive to reduce volatilization of a solvent.

18. The CMP slurry of claim 1, wherein the slurry is used to polish a semiconductor layer by:
a. forming a dielectric layer on a semiconductor substrate;
b. patterning the dielectric layer;
c. lining the trench and via with barrier material;
d. filling a metal Al or Al alloys into the trenches and via; and
e. applying CMP with the slurry to the Al or Al alloy film.

19. The CMP slurry of claim 1, wherein the slurry is used to polish an Al or Al alloy surface to improve its smoothness, optical reflectivity, and planarity in both global and local scales.

20. The CMP slurry of claim 1, wherein the slurry contains an abrasive particle with an empty inner portion.

21. The CMP slurry of claim 20, wherein the abrasive particle comprises one of the following: SiO₂, Al₂O₃, CaCO₃, ZrO, CeO₂, TiO₂ Si₃N₄, AlN, TiN. SiC Al(OH)₃, polymer including polyethylene, PTFE, and a combination thereof.
